(19) United States
(12) Patent Application Publication
(10) Pub. No.: US 2014/0029728 A1
(43) Pub. Date: Jan. 30, 2014

(54) High-Efficiency Flat Type Photo Bar Using Field Emitter and Manufacturing Method Thereof

(71) Applicants: Do Yun Kim, Daejeon (KR); Dae Jun Kim, Daejeon (KR)

(72) Inventors: Do Yun Kim, Daejeon (KR); Dae Jun Kim, Daejeon (KR)

(73) Assignee: VSI CO., LTD., Daejeon (KR)

(21) Appl. No.: 13/988,489

(22) PCT Filed: Dec. 16, 2011
(86) PCT No.: PCT/KR11/09694

§ 371 Date: Oct. 9, 2013

(30) Foreign Application Priority Data
Apr. 4, 2011 (KR) 10-2011-0030510

(51) Int. Cl. H01J 35/02

(52) U.S. Cl. CPC H01J 35/02
USPC 378/122

(57) ABSTRACT

A high-efficiency flat type photo bar using a field emitter and a manufacturing method thereof, including: a substrate; a cathode part which is formed as an electrode on an upper portion of the substrate; a nano-field emitter which is patterned at a constant interval on the cathode part; a gate part which is formed horizontally to the cathode part so as to induce the emission of electrons from the field emitter; and an anode part which is insulated and separated from an upper portion of the gate part so as to be formed horizontally to the upper portion of the gate part and comprises a target material.

### CROSS-REFERENCE TO RELATED APPLICATIONS

This application is the U.S. national phase of International Patent Application No. PCT/KR2011/009694 filed Dec. 16, 2011, which claims the benefit of Korean Patent Application No. 10-2011-0030510 filed Apr. 4, 2011, the entire content of which is incorporated herein by reference.

### FIELD OF THE INVENTION

Embodiments relate to a high-efficiency flat type photo bar using a field emitter and a method of manufacturing the same, and, more particularly, to a high-efficiency flat type photo bar using a field emitter, which can remove static electricity and dust, both of which have a direct influence on the production yield in process lines of semiconductors and displays, and to a method of manufacturing the same.

### BACKGROUND

In order to remove static electricity and dust which directly affect the production yield in process lines of semiconductors and displays, a so-called “ionizer” is recently receiving attention.

A commonly used ionization method using such an ionizer is exemplified by an ionization method using corona discharge effects, and further, a photo-ionization method and device using X-rays are being technically developed, and have resulted in considerable growth in terms of market activity.

However, such a conventional ionization method using corona discharge essentially requires periodic cleaning because ionized products may be adsorbed onto the discharge tip and thereby dust (particles) may be formed. When this goes unnoticed, critical problems may be caused in a production line. Thus, the ionizer using X-rays is used to solve such problems, but is problematic in that a plurality of X-ray tubes should be arranged due to a limitation of the ionization region of a single X-ray tube.

The problems of increasing non-uniformity of the ionization properties and causing complication of power devices and driving devices with high costs have not yet been solved, and also, conventional X-ray tubes adopt a thermoelectron (filament) type, and may thus be inefficient in terms of power consumption efficiency and response rate.

Therefore, a photo-photo bar (hereinafter referred to as a “photo bar”) used to date for large-area ionization mainly comprises an ionizer using corona discharge, taking into consideration cost problems and ionization properties.

The invention has been made keeping in mind the above problems occurring in the related art, and embodiments of the invention provide a photo bar, which is capable of generating large-area X-rays based on a cold cathode using a nano-field emitter as an electron source, and a method of manufacturing the same.

A first embodiment of the invention provides a high-efficiency flat type photo bar using a field emitter, comprising a substrate; a cathode part formed as an electrode on the substrate; a nano-field emitter patterned by a predetermined interval on the cathode part; a gate part, which is insulatively spaced apart from an upper surface of the field emitter, is formed parallel to the cathode part, and induces emission of electrons from the field emitter; and an anode part, which is insulatively spaced apart from an upper surface of the gate part to be formed parallel thereto and comprises a target material.

A second embodiment of the invention provides a high-efficiency flat type photo bar using a field emitter, comprising a substrate; a cathode part and a gate part, which are dividedly formed as a number of electrodes on the substrate; a nano-field emitter patterned on the cathode part and the gate part; and an anode part insulatively spaced apart from an upper surface of the cathode part and the gate part to be formed parallel thereto and including a target material.

A third embodiment of the invention provides a high-efficiency flat type photo bar using a field emitter, comprising a substrate; a cathode part and a gate part alternately formed by a nano-sized fine gap as a number of electrodes on the substrate; and an anode part insulatively spaced apart from an upper surface of the cathode part and the gate part to be formed parallel thereto and including a target material.

In the high-efficiency flat type photo bar using the field emitter according to the first to third embodiments of the invention, in the case where the cathode part, the gate part and the anode part are formed to be large, the photo bar may further comprise an insulation spacer formed perpendicular to the substrate and the anode part between the substrate and the anode part so that an internal structure formed in a vacuum is supported under atmospheric pressure.

In the high-efficiency flat type photo bar using the field emitter according to the first or second embodiment of the invention, the field emitter may be typically provided using a nano wire type material having a very large inner diameter-to-length ratio, including a carbon nanotube (CNT), and is preferably provided as any one among tips etched in a cone form using a nano-carbon type material including CNT (Carbon Nano Tube), CNF (Carbon Nano Fiber), CNW (Carbon Nano Wall), GNF (Graphite Nano Fiber), or graphene, an oxide nano wire type material including a ZnO2 nano wire or a TiO2 nano wire, a nitride TiN nano wire, a metal including tungsten (W) or molybdenum (Mo), silicon (Si), or diamond.

In the high-efficiency flat type photo bar using the field emitter according to the first to third embodiments of the invention, the anode part may be configured such that the target material is formed on the substrate made of any one material selected from among glass, ceramic and a metal.

In addition, the invention provides a method of manufacturing the high-efficiency flat type photo bar using the field emitter according to the first embodiment of the invention, comprising (A) forming a cathode part on a substrate using screen printing, gravure printing, offset printing, ink-jet printing or film deposition, or photoexposure and development; (B) forming a nano-field emitter on the cathode part using screen printing, gravure printing, offset printing, ink-jet printing or film deposition, or photoexposure and development; (C) forming a gate part to be spaced apart from an upper surface of the cathode part by a predetermined interval to ensure insulation; (D) forming an anode part including a target material above the gate part; and (E) performing vacuum packaging between the substrate and the anode part after (D).

The invention provides a method of manufacturing the high-efficiency flat type photo bar using the field emitter according to the second embodiment of the invention, comprising (a) forming a cathode part and a gate part by a predetermined interval on a substrate using screen printing, gravure printing, offset printing, ink-jet printing or film deposition, or photoexposure and development; (b) forming a nano-field emitter on the cathode part and the gate part; (c) forming an anode part including a target material above the cathode part and the gate part; and (d) performing vacuum packaging between the substrate and the anode part after (c).

The invention provides a method of manufacturing the high-efficiency flat type photo bar using the field emitter according to the third embodiment of the invention, comprising (1) forming a cathode part and a gate part on a substrate using screen printing, gravure printing, offset printing, ink-jet printing or film deposition, or photoexposure and development; (2) forming an anode part including a target material above the substrate; and (3) performing vacuum packaging between the substrate and the anode part after (2).

In the method of manufacturing the high-efficiency flat type photo bar using the field emitter according to the first to third embodiments of the invention, in the case where the cathode part, the gate part and the anode part are formed to be large, the method may further comprise forming an insulation spacer between the substrate and the anode part to be perpendicular to the substrate and the anode part so that an internal structure formed in a vacuum is supported under atmospheric pressure.

In the method of manufacturing the high-efficiency flat type photo bar using the field emitter according to the first to third embodiments of the invention, the cathode part may be formed of any one selected from among a metal (for example Ag, Cu), an oxide electrode material (for example ITO), and a carbonaceous electrode material (for example graphene and CNT).

In the method of manufacturing the high-efficiency flat type photo bar using the field emitter according to the first or second embodiment of the invention, the nano-field emitter may be formed using any one process selected from among pasting, direct growth, slurry application, electrophoresis, and dipping.

In the method of manufacturing the high-efficiency flat type photo bar using the field emitter according to the first embodiment of the invention, the gate part may be formed in such a manner that a metal plate is etched and aligned with the nano-field emitter, or that a glass plate or a ceramic plate is etched and then an electrode is formed on one side thereof, or may be formed via direct printing using a screen printing process.

In the method of manufacturing the high-efficiency flat type photo bar using the field emitter according to the first to third embodiments of the invention, the anode part should be spaced apart from the gate part to an extent of being able to maintain high-voltage insulation, and the target material able to emit X-rays may be formed using any one process selected from among deposition, coating and screen printing.

According to embodiments of the invention, a photo bar and a manufacturing method thereof are provided using a cold cathode type nano-field emitter as an electron source, thus causing no problems related to adsorption and desorption of dust, compared to a corona discharge type, and attaining ionization capability by virtue of low power consumption, high efficiency and digital driving, while achieving an integrated large-area, planar structure, unlike conventional thermoelectron type X-ray tubes.

### BRIEF DESCRIPTION OF THE DRAWINGS

FIG. 1 is a perspective view illustrating a high-efficiency flat type photo bar using a field emitter according to a first embodiment of the invention;

FIG. 2 is a cross-sectional view illustrating the high-efficiency flat type photo bar using the field emitter according to the first embodiment of the invention;

FIG. 3 is a cross-sectional view illustrating a high-efficiency flat type photo bar using a field emitter according to a second embodiment of the invention;

FIG. 4 is a cross-sectional view illustrating a high-efficiency flat type photo bar using a field emitter according to a third embodiment of the invention;

FIG. 5 is a flowchart illustrating a process of manufacturing the high-efficiency flat type photo bar using the field emitter according to the first embodiment of the invention;

FIG. 6 is a flowchart illustrating a process of manufacturing the high-efficiency flat type photo bar using the field emitter according to the second embodiment of the invention; and

FIG. 7 is a flowchart illustrating a process of manufacturing the high-efficiency flat type photo bar using the field emitter according to the third embodiment of the invention.

### DETAILED DESCRIPTION OF THE INVENTION

Hereinafter, a detailed description will be given of specific embodiments of the invention with reference to the appended drawings.

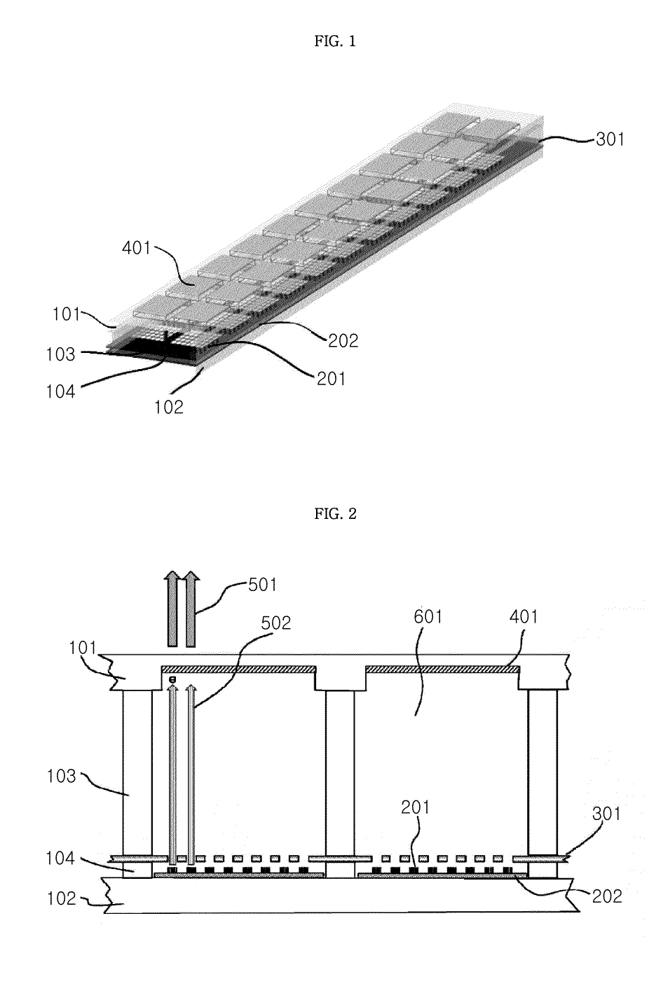

FIG. 1 is a perspective view illustrating a high-efficiency flat type photo bar using a field emitter according to a first embodiment of the invention, and FIG. 2 is a cross-sectional view illustrating the high-efficiency flat type photo bar using the field emitter according to the first embodiment of the invention.

As illustrated in FIGS. 1 and 2, the high-efficiency flat type photo bar using the field emitter according to the first embodiment of the invention comprises a substrate 102, a cathode part 202 formed as an electrode on the substrate 102, a nano-field emitter 201 patterned by a predetermined interval on the cathode part 202, a gate part 301, which is insulatively spaced apart from the upper surface of the field emitter 201, is formed parallel to the cathode part 202 and induces emission of electrons from the field emitter 201, and an anode part 101, which is insulatively spaced apart from the upper surface of the gate part 301 to be formed parallel thereto and comprises a target material 401.

In the case where the cathode part 202, the gate part 301 and the anode part 101 are formed to be large, the photo bar may further comprise insulation spacers 103, 104 which are formed perpendicular to the substrate 102 and the anode part 101 between the substrate 102 and the anode part 101 so that the internal structure formed in a vacuum is supported under atmospheric pressure.

The insulation spacer 104 is positioned between the substrate 102 and the gate part 301, and the insulation spacer 103 is positioned between the gate part 301 and the anode part 101.

The field emitter 201 may be typically provided using a nano wire type material having a very large inner diameter-to-length ratio, such as a carbon nanotube (CNT), and is preferably provided as any one among tips etched in the form of a cone using a nano-carbon type material such as CNT (Carbon Nano Tube), CNF (Carbon Nano Fiber), CNW (Carbon Nano Wall), GNF (Graphite Nano Fiber), or graphene, an oxide nano wire type material such as a ZnO2 nano wire, or a TiO2 nano wire, a nitride TiN nano wire, a metal such as tungsten (W) or molybdenum (Mo), silicon (Si), or diamond.

The anode part 101 is configured such that the target material 401 is formed on the substrate made of any one material selected from among glass, ceramic and a metal.

Below is a description of the operating principle of the high-efficiency flat type photo bar using the field emitter according to the first embodiment of the invention.

When a voltage is applied to the gate part 301 which induces the emission of electrons, an electric field is intensively applied to the nano-field emitter 201 formed on the cathode part 202, and thus electrons 501 are emitted to the vacuum 601 from the nano-field emitter 201. The electronic beams 501 emitted from the nano-field emitter 201 reach the anode part 101 spaced apart by a predetermined distance via the insulation spacers 103, 104, and are thus finally converted into X-rays 502, which is described below.

The anode part 101 may be configured such that the target material 401 is formed on the substrate, and, as illustrated in FIGS. 1 and 2, a region where the target (target material) 401 will be formed may be processed to be thin depending on the material and thickness of the substrate. In the embodiment, the substrate on which the anode part 101 is formed is determined to be glass, and a variety of materials, including ceramic, metal, etc., in addition to glass, may be utilized.

In the case of the field emission photo bar as illustrated in FIG. 1 according to the first embodiment of the invention, because current switching operation is possible on the cathode part 202 using a high-voltage transistor in a state of a DC voltage being applied to the anode part 101 and the gate part 301, the photo bar according to the first embodiment of the invention has a small structure and may thus be easily driven even by low power.

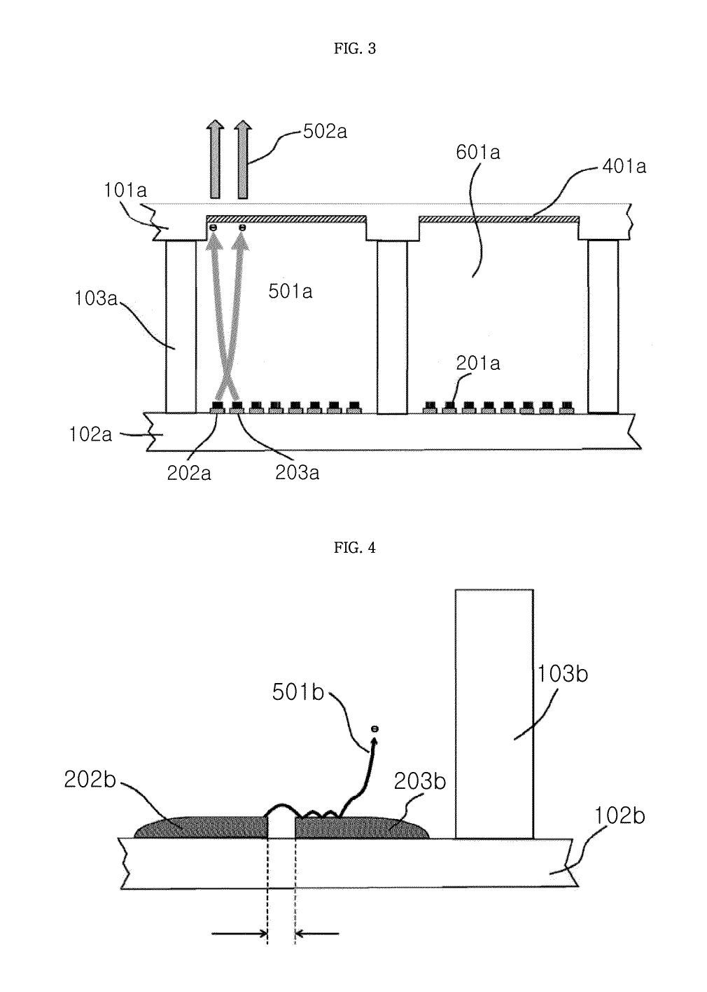

FIG. 3 is a cross-sectional view illustrating a high-efficiency flat type photo bar using a field emitter according to a second embodiment of the invention.

As illustrated in FIG. 3, the high-efficiency flat type photo bar using the field emitter according to the second embodiment of the invention comprises a substrate 102a, a cathode part 202a and a gate part 203a, which are dividedly formed as a number of electrodes on the substrate 102a, a nano-field emitter 201a patterned on the cathode part 202a and the gate part 203a, and an anode part 101a insulatively spaced apart from the upper surface of the cathode part 202a and the gate part 203a to be formed parallel thereto and including a target material 401a.

In the case where the cathode part 202a, the gate part 203a and the anode part 101a are formed to be large, the photo bar may further comprise an insulation spacer 103a which is formed perpendicular to the substrate 102a and the anode part 101a between the substrate 102a and the anode part 101a so that the internal structure formed in a vacuum is supported under atmospheric pressure.

The field emitter 201a may be typically provided using a nano wire type material having a very large inner diameter-to-length ratio, such as a carbon nanotube (CNT), and is preferably provided as any one among tips etched in the form of a cone using a nano-carbon type material such as CNT (Carbon Nano Tube), CNF (Carbon Nano Fiber), CNW (Carbon Nano Wall), GNF (Graphite Nano Fiber), or graphene, an oxide nano wire type material such as a ZnO2 nano wire or a TiO2 nano wire, a nitride TiN nano wire, a metal such as tungsten (W) or molybdenum (Mo), silicon (Si), or diamond.

The anode part 101a is configured such that the target material 401a is formed on the substrate made of any one material selected from among glass, ceramic, and a metal.

Below is a description of the operating principle of the high-efficiency flat type photo bar using the field emitter according to the second embodiment of the invention.

FIG. 3 illustrates a modification of the electron emitter which emits electrons, in the same structure as in the photo bar of FIGS. 1 and 2.

In the structure of FIG. 3, the cathode part 202a and the gate part 203a are driven while intersecting with each other. In particular, the cathode part 202a and the gate part 203a which are adjacent to each other are driven differently. When the electrode is used as the cathode part 202a, the adjacent electrode is used as the gate part 203a. When the electrode which was the cathode part 202a is used as the gate part 203a, the electrode which was the gate part 203a is used as the cathode part 202a.

In FIG. 3, the reference numeral 501a designates electrons or electronic beams, the reference numeral 502a designates X-rays, and the reference numeral 601a designates a vacuum.

FIG. 4 is a cross-sectional view illustrating a high-efficiency flat type photo bar using a field emitter according to a third embodiment of the invention.

As illustrated in FIG. 4, the high-efficiency flat type photo bar using the field emitter according to the third embodiment of the invention comprises a substrate 102b, a cathode part 202b and a gate part 203b alternately formed by a nano-sized fine gap as a number of electrodes on the substrate 102b, and an anode part (not shown) insulatively spaced apart from the upper surface of the cathode part 202b and the gate part 203b to be formed parallel thereto and including a target material.

Although the anode part is not shown in FIG. 4 which illustrates the photo bar according to the third embodiment of the invention, it preferably has the same configuration as in the anode parts 101, 101a of the photo bars according to the first and second embodiments illustrated in FIGS. 2 and 3.

In the case where the cathode part 202b, the gate part 301b and the anode part are formed to be large, the photo bar may further comprise an insulation spacer 103b formed perpendicular to the substrate 102a and the anode part between the substrate 102a and the anode part so that the internal structure formed in a vacuum is supported under the atmospheric pressure.

Below is a description of the operating principle of the high-efficiency flat type photo bar using the field emitter according to the third embodiment of the invention.

FIG. 4 illustrates a modified field emission structure in the field emission type photo bars according to the invention described with reference to FIGS. 1 to 3. Although the electron emission structure emitted from the nano wire and the nano tip is illustrated in the above embodiments, the photo bar of FIG. 4 is configured such that two electrodes are formed on the substrate 102b by a nano-sized fine gap, and when a voltage is applied to the gate part 203b, electrons are emitted from the cathode part 202b toward the gate part 203b, wherein a portion of the emitted electrons is not directed to the gate part 203b but is scattered and thus directed toward the anode part. In FIG. 4, the gate part 203b and the cathode part 202b may be driven while intersecting with each other, as in FIG. 3.

In FIG. 4, the reference numeral 501b designates electrons or electronic beams.

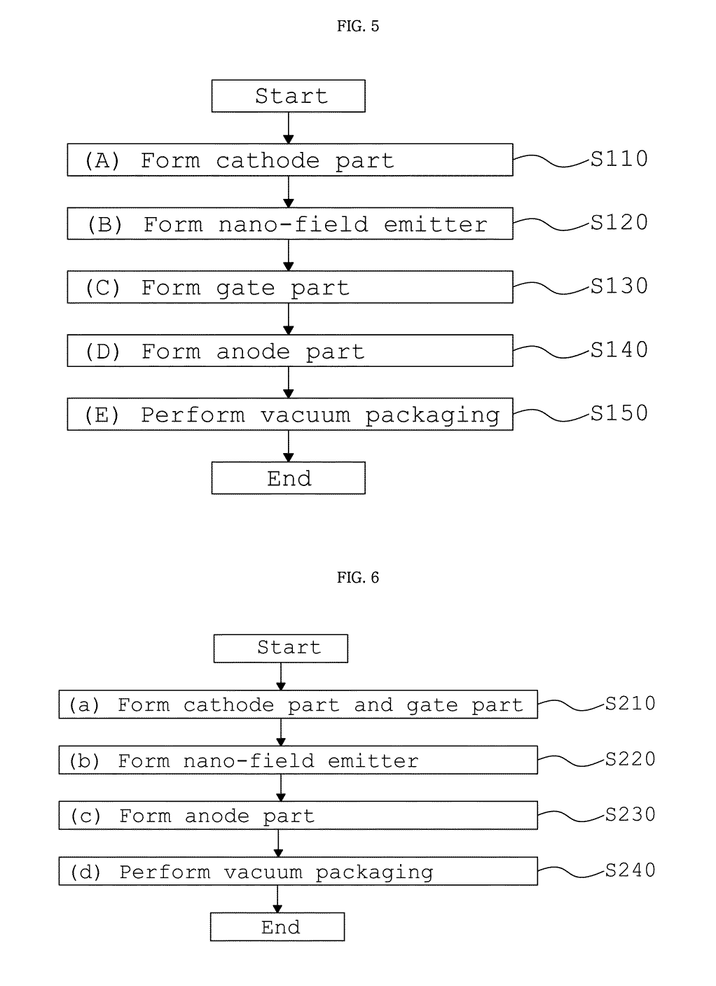

FIG. 5 is a flowchart illustrating a process of manufacturing the high-efficiency flat type photo bar using the field emitter according to the first embodiment of the invention.

As illustrated in FIG. 5, the method of manufacturing the high-efficiency flat type photo bar using the field emitter according to the first embodiment of the invention comprises (A) forming a cathode part 202 on a substrate 102 using screen printing, gravure printing, offset printing, ink-jet printing or film deposition, or photoexposure and development (S110), (B) forming a nano-field emitter 201 on the cathode part 202 using screen printing, gravure printing, offset printing, ink-jet printing or film deposition, or photoexposure and development (S120), (C) forming a gate part 301 to be spaced apart from the upper surface of the cathode part 202 by a predetermined interval to ensure insulation (S130), (D) forming an anode part 101 including a target material 401 above the gate part 301 (S140), and (E) performing vacuum packaging between the substrate 102 and the anode part 101 (S150) after (D) (S140).

In the case where the cathode part 202, the gate part 301 and the anode part 101 are formed to be large, the method may further comprise forming insulation spacers 103, 104 between the substrate 102 and the anode part 101 to be perpendicular to the substrate and the anode part so that the internal structure formed in a vacuum is supported under the atmospheric pressure.

The insulation spacer 104 is positioned between the substrate 102 and the gate part 301, and the insulation spacer 103 is positioned between the gate part 301 and the anode part 101.

The cathode part 202 is formed of any one selected from among a metal (for example Ag, Cu), an oxide electrode material (for example ITO), and a carbonaceous electrode material (for example graphene and CNT).

The nano-field emitter 201 is formed using any one process selected from among pasting, direct growth, slurry application, electrophoresis, and dipping.

The gate part 301 is formed in such a manner that a metal plate is etched and aligned with the nano-field emitter 201, or that a glass plate or a ceramic plate is etched and then an electrode is formed on one side thereof, or is formed via direct printing using a screen printing process.

The anode part 101 should be spaced apart from the gate part 301 to an extent of being able to maintain high-voltage insulation, and the target material 401 able to emit X-rays is formed using any one process selected from among deposition, coating and screen printing.

FIG. 6 is a flowchart illustrating a process of manufacturing the high-efficiency flat type photo bar using the field emitter according to the second embodiment of the invention.

As illustrated in FIG. 6, the method of manufacturing the high-efficiency flat type photo bar using the field emitter according to the second embodiment of the invention comprises (a) forming a cathode part 202a and a gate part 203a by a predetermined interval on a substrate 102a using screen printing, gravure printing, offset printing, ink-jet printing or film deposition, or photoexposure and development (S210), (b) forming a nano-field emitter 210a on the cathode part 202a and the gate part 203a (S220), (c) forming an anode part 101a including a target material 401a above the cathode part 202a and the gate part 203a (S230), and (d) performing vacuum packaging between the substrate 102a and the anode part 101a (S240) after (c) (S230).

In the case where the cathode part 202a, the gate part 203a and the anode part 101a are formed to be large, the method may further comprise forming an insulation spacer 103a between the substrate 102a and the anode part 101a to be perpendicular to the substrate and the anode part so that the internal structure formed in a vacuum is supported under the atmospheric pressure.

The cathode part 202a is formed of any one selected from among a metal (for example Ag, Cu), an oxide electrode material (for example ITO), and a carbonaceous electrode material (for example graphene and CNT).

The nano-field emitter 201a is formed using any one process selected from among pasting, direct growth, slurry application, electrophoresis, and dipping.

The anode part 101a should be spaced apart from the gate part 203a to an extent of being able to maintain high-voltage insulation, and the target material 401a able to emit X-rays is formed using any one process selected from among deposition, coating and screen printing.

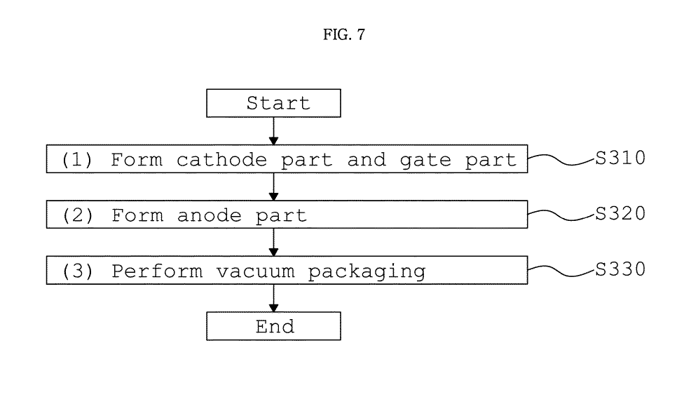

FIG. 7 is a flowchart illustrating a process of manufacturing the high-efficiency flat type photo bar using the field emitter according to the third embodiment of the invention.

As illustrated in FIG. 7, the method of manufacturing the high-efficiency flat type photo bar using the field emitter according to the third embodiment of the invention comprises (1) forming a cathode part 202b and a gate part 203b on a substrate 102b using screen printing, gravure printing, offset printing, ink-jet printing or film deposition, or photoexposure and development (S310), (2) forming an anode part including a target material above the substrate 102b (S320), and (3) performing vacuum packaging between the substrate 102b and the anode part (S330) after (2) (S320).

In the case where the cathode part 202b, the gate part 301b and the anode part 101b are formed to be large, the method may further comprise forming an insulation spacer 103b between the substrate 102b and the anode part 101b to be perpendicular to the substrate and the anode part so that the internal structure formed in a vacuum is supported under the atmospheric pressure.

The cathode part 202b is formed of any one selected from among a metal (for example Ag, Cu), an oxide electrode material (for example ITO), and a carbonaceous electrode material (for example graphene and CNT).

The anode part should be spaced apart from the gate part 203b to an extent of being able to maintain high-voltage insulation, and the target material 401a able to emit X-rays is formed using any one process selected from among deposition, coating and screen printing.

The anode part is not shown in FIG. 4 which illustrates the photo bar according to the third embodiment, but preferably has the same configuration as in the anode parts 101, 101a of the photo bars according to the first and second embodiments illustrated in FIGS. 2 and 3.

The preferred embodiments of the invention have been disclosed for illustrative purposes, but those skilled in the art will appreciate that various modifications are possible, without departing from the scope and spirit of the invention as disclosed in the accompanying claims. The scope of the invention is not limited to the illustrated embodiments, and has to be determined by the following claims and the equivalents thereto.

### DESCRIPTION OF THE REFERENCE NUMERALS IN THE DRAWINGS

101, 101a: anode part
102, 102a, 102b: substrate
103, 103a, 103b, 104: insulation spacer
201, 201a: field emitter
202, 202a, 202b: cathode part
203a, 203b, 301: gate part
401, 401a: target material

1. A high-efficiency flat type photo bar using a field emitter, comprising:
a substrate;
a cathode part formed as an electrode on the substrate;
a nano-field emitter patterned by a predetermined interval on the cathode part;
a gate part, which is insulatively spaced apart from an upper surface of the field emitter, is formed parallel to the cathode part, and induces emission of electrons from the field emitter; and
an anode part, which is insulatively spaced apart from an upper surface of the gate part to be formed parallel thereto and comprises a target material.

2. A high-efficiency flat type photo bar using a field emitter, comprising:
a substrate;
a cathode part and a gate part, which are dividedly formed as a number of electrodes on the substrate;
a nano-field emitter patterned on the cathode part and the gate part; and
an anode part insulatively spaced apart from an upper surface of the cathode part and the gate part to be formed parallel thereto and comprising a target material.

3. A high-efficiency flat type photo bar using a field emitter, comprising:
a substrate;
a cathode part and a gate part alternately formed by a nano-sized fine gap as a number of electrodes on the substrate; and
an anode part insulatively spaced apart from an upper surface of the cathode part and the gate part to be formed parallel thereto and comprising a target material.

4. The high-efficiency flat type photo bar of claim 1, wherein, in a case where the cathode part, the gate part and the anode part are formed to be large, the photo bar further comprises an insulation spacer formed perpendicular to the substrate and the anode part between the substrate and the anode part so that an internal structure formed in a vacuum is supported under atmospheric pressure.

5. The high-efficiency flat type photo bar of claim 1, wherein the field emitter is typically provided using a nano wire type material having a very large inner diameter-to-length ratio, including a carbon nanotube (CNT), and is preferably provided as any one among tips etched in a cone form using a nano-carbon type material including CNT (Carbon Nano Tube), CNF (Carbon Nano Fiber), CNW (Carbon Nano Wall), GNF (Graphite Nano Fiber), or graphene, an oxide nano wire type material including a ZnO2 nano wire or a TiO2 nano wire, a nitride TiN nano wire, a metal including tungsten (W) or molybdenum (Mo), silicon (Si), or diamond.

6. The high-efficiency flat type photo bar of claim 1, wherein the anode part is configured such that the target material is formed on the substrate made of any one material selected from among glass, ceramic and a metal.

7. A method of manufacturing a high-efficiency flat type photo bar using a field emitter, comprising:
(a) forming a cathode part on a substrate using screen printing, gravure printing, offset printing, inkjet printing or film deposition, or photoexposure and development;
(b) forming a nano-field emitter on the cathode part using screen printing, gravure printing, offset printing, ink-jet printing or film deposition, or photoexposure and development;
(c) forming a gate part to be spaced apart from an upper surface of the cathode part by a predetermined interval to ensure insulation;
(d) forming an anode part including a target material above the gate part; and
(e) performing vacuum packaging between the substrate and the anode part after (d).

8. A method of manufacturing a high-efficiency flat type photo bar using a field emitter, comprising:
(a) forming a cathode part and a gate part by a predetermined interval on a substrate using screen printing, gravure printing, offset printing, ink jet printing or film deposition, or photoexposure and development;
(b) forming a nano-field emitter on the cathode part and the gate part;
(c) forming an anode part including a target material above the cathode part and the gate part; and
(d) performing vacuum packaging between the substrate and the anode part after (c).

9. A method of manufacturing a high-efficiency flat type photo bar using a field emitter, comprising:
(1) forming a cathode part and a gate part on a substrate using screen printing, gravure printing, offset printing, ink jet printing or film deposition, or photoexposure and development;
(2) forming an anode part including a target material above the substrate; and
(3) performing vacuum packaging between the substrate and the anode part after (2).

10. The method of claim 7, wherein, in a case where the cathode part, the gate part and the anode part are formed to be large, the method further comprises forming an insulation spacer between the substrate and the anode part to be perpendicular to the substrate and the anode part so that an internal structure formed in a vacuum is supported under atmospheric pressure.

11. The method of claim 7, wherein the cathode part is formed of any one selected from among a metal (for example Ag, Cu), an oxide electrode material (for example ITO), and a carbonaceous electrode material (for example graphene and CNT).

12. The method of claim 7, wherein the nano-field emitter is formed using any one process selected from among pasting, direct growth, slurry application, electrophoresis, and dipping.

13. The method of claim 7, wherein the gate part is formed in such a manner that a metal plate is etched and aligned with the nano-field emitter, or that a glass plate or a ceramic plate is etched and then an electrode is formed on one side thereof, or is formed via direct printing using a screen printing process.

14. The method of claim 7, wherein the anode part should be spaced apart from the gate part to an extent of being able to maintain high-voltage insulation, and the target material able to emit X-rays is formed using any one process selected from among deposition, coating and screen printing.
